(19) United States
(12) Patent Application Publication
(10) Pub. No.: US 2026/0359762 A1
(43) Pub. Date: Nov. 12, 2026

(54) SYSTEMS AND METHODS FOR AUGMENTED OPTIMAL DECISION-MAKING

(71) Applicant: Fidelity Information Services, LLC, Jacksonville, FL (US)

(72) Inventor: Ranadhir GHOSH, St. Johns, FL (US)

(21) Appl. No.: 19/205,381

(22) Filed: May 12, 2025

(51) Int. Cl. G06Q 10/0637; G06N 20/00; G06Q 10/0631; G06Q 10/0639

(52) U.S. Cl. CPC G06Q 10/0637; G06N 20/00; G06Q 10/06316; G06Q 10/06393

(57) ABSTRACT

A method may include receiving data from a plurality of data sources, the data comprising at least one of structured or unstructured information related to at least one of client interactions, product performance, marketing, financial metrics, or service operations; extracting a plurality of data points from the data; organizing the plurality of data points into a plurality of entities, the plurality of entities comprising at least one of information entities, event entities, action entities, or benchmark entities; processing the plurality of data points via an analytical engine comprising one or more machine-learning models configured to identify insights and relationships between the plurality of entities; determining a set of actions to improve client experience, based on the insights and the relationships derived from the analytical engine; and transmitting the set of actions to a user interface or an autonomous agent for implementation.

### TECHNICAL FIELD

Various embodiments of the present disclosure relate generally to augmented client experience systems and methods and, more particularly, to systems and methods for optimal decision-making based on client information.

### BACKGROUND

Enterprises collect increasingly more client data related to numerous departments. Enterprises may rely on their sales department, customer service department, marketing department, risk management department, etc. to interact with the client in different capacities. Enterprises often struggle to align department efforts with one another, which can lead to subpar client relationships. For example, the sales department of an enterprise may be aware of a pending merger, but the marketing department is not. The marketing department may then make a suggestion to the client that does not fulfill the needs or wants of the client based on the upcoming merger. Thus, there is a need to effectively manage and update client data between departments so the enterprise can make optimal decisions.

The disclosure herein describes a solution that aligns enterprise-wide efforts of all verticals (e.g., departments) to improve client experience. Enterprises may be able to better understand client needs based on compiling various kinds of data silos and insights. Department teams are more confident as they are provided with accurate, up-to-date data related to the client. This leads to better client relationships and reduces client attrition. Specifically, the disclosure herein provides actionable insights for the department teams based on the client data collected, thereby providing an augmented optimal decision-making system.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

In some aspects, the techniques described herein relate to a computer-implemented method for autonomous decision optimization, the method including: receiving, by one or more processors, data from a plurality of data sources, the data including at least one of structured or unstructured information related to at least one of client interactions, product performance, marketing, financial metrics, or service operations; extracting, by the one or more processors, a plurality of data points from the data; organizing, by the one or more processors, the plurality of data points into a plurality of entities, the plurality of entities including at least one of information entities, event entities, action entities, or benchmark entities; processing, by the one or more processors, the plurality of data points via an analytical engine including one or more machine-learning models configured to identify insights and relationships between the plurality of entities; determining, by the one or more processors, a set of actions to improve client experience, based on the insights and the relationships derived from the analytical engine; and transmitting, by the one or more processors, the set of actions to a user interface or an autonomous agent for implementation.

In some aspects, the techniques described herein relate to a computer-implemented method, wherein the data includes at least one of customer relationship management data, ticketing data, product usage data, software development data, financial news data, or social media content data.

In some aspects, the techniques described herein relate to a computer-implemented method, further including: representing, by the one or more processors, each entity of the plurality of entities in at least one of a machine-readable JSON format or a knowledge graph format, each entity of the plurality of entities including timestamped attribute data and inter-entity relationship data.

In some aspects, the techniques described herein relate to a computer-implemented method, further including: automatically implementing, by the one or more processors, at least one of the set of actions.

In some aspects, the techniques described herein relate to a computer-implemented method, wherein the set of actions includes at least one of initiating marketing outreach, altering product development focus, recommending client support interventions, or prioritizing customer segments.

In some aspects, the techniques described herein relate to a computer-implemented method, wherein the set of actions is determined based on correlation between historical event entities and benchmark performance metrics.

In some aspects, the techniques described herein relate to a computer-implemented method, wherein the set of actions is provided to one or more autonomous AI agents configured to execute workflows based on the set of actions.

In some aspects, the techniques described herein relate to a computer-implemented method, further including: detecting, by the one or more processors, anomalies in benchmark entity performance metrics over a defined time window; identifying, by the one or more processors, one or more root cause event entities correlated with the anomalies; and recommending, by the one or more processors, targeted action entities to address the one or more root cause event entities.

In some aspects, the techniques described herein relate to a computer-implemented method, wherein each entity of the plurality of entities is uniquely identified using a hierarchical identifier including a module name, an entity class name, and an entity name.

In some aspects, the techniques described herein relate to a computer-implemented method, wherein the client experience improvements include increased net promoter scores, enhanced upselling and cross-selling outcomes, and reductions in client turnover rates.

In some aspects, the techniques described herein relate to a computer-implemented method, wherein each benchmark entity includes a time-dependent performance target derived from aggregated historical data across industry or enterprise benchmarks.

In some aspects, the techniques described herein relate to a computer-implemented method, further including: receiving user feedback related to a selected action; retraining, by the one or more processors, the one or more machine-learning models based on the user feedback to improve future decision accuracy.

In some aspects, the techniques described herein relate to a computer-implemented method, wherein the one or more machine-learning models are trained using historical data including at least one of past event outcomes, client feedback, benchmark targets, or action effectiveness metrics.

In some aspects, the techniques described herein relate to a system for autonomous decision optimization, the system including: a memory storing instructions and one or more machine-learning models; and a processor operatively connected to the memory and configured to execute the instructions to perform operations including: receiving, by one or more processors, data from a plurality of data sources, the data including at least one of structured or unstructured information related to at least one of client interactions, product performance, marketing, financial metrics, or service operations; extracting, by the one or more processors, a plurality of data points from the data; organizing, by the one or more processors, the plurality of data points into a plurality of entities, the plurality of entities including at least one of information entities, event entities, action entities, or benchmark entities; processing, by the one or more processors, the plurality of data points via an analytical engine including the one or more machine-learning models configured to identify insights and relationships between the plurality of entities; determining, by the one or more processors, a set of actions to improve client experience, based on the insights and the relationships derived from the analytical engine; and transmitting, by the one or more processors, the set of actions to a user interface or an autonomous agent for implementation.

In some aspects, the techniques described herein relate to a system, wherein the processor operatively connected to the memory and configured to execute the instructions to perform operations further includes: representing each of the plurality of entities in at least one of a machine-readable JSON format or a knowledge graph format, each entity of the plurality of entities including timestamped attribute data and inter-entity relationship data.

In some aspects, the techniques described herein relate to a system, wherein the set of actions is provided to one or more autonomous AI agents configured to execute workflows based on the set of actions.

In some aspects, the techniques described herein relate to a system, wherein the system is configured to operate in real-time by continuously receiving and updating entity representations from streaming data sources.

In some aspects, the techniques described herein relate to a system, wherein the processor operatively connected to the memory and configured to execute the instructions to perform operations further includes: automatically implementing at least one of the set of actions.

In some aspects, the techniques described herein relate to a non-transitory machine-readable medium storing instructions that, when executed by one or more processors, cause a client experience system to perform a method for autonomous decision optimization, the method including: receiving, by one or more processors, data from a plurality of data sources, the data including at least one of structured or unstructured information related to at least one of client interactions, product performance, marketing, financial metrics, or service operations; extracting, by the one or more processors, a plurality of data points from the data; organizing, by the one or more processors, the plurality of data points into a plurality of entities, the plurality of entities including at least one of information entities, event entities, action entities, or benchmark entities; processing, by the one or more processors, the plurality of data points via an analytical engine including one or more machine-learning models configured to identify insights and relationships between the plurality of entities; determining, by the one or more processors, a set of actions to improve client experience, based on the insights and the relationships derived from the analytical engine; and transmitting, by the one or more processors, the set of actions to a user interface or an autonomous agent for implementation.

In some aspects, the techniques described herein relate to a non-transitory machine-readable medium, the method performed by the client experience system further including: automatically implementing at least one of the set of actions.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic of an optimal decision-making system, according to one or more embodiments.

FIG. 2 is a flowchart showing a process for determining optimal actions, according to one or more embodiments.

FIG. 3 illustrates a flow diagram for training a machine-learning model, according to one or more embodiments.

FIG. 4 illustrates an implementation of a computer system that executes techniques presented herein, according to one or more embodiments.

FIG. 5 illustrates a framework for the optimal decision-making system of FIG. 1, according to one or more embodiments.

FIG. 6 illustrates a diagram of entity modules, according to one or more embodiments.

FIGS. 7A-7D depict diagrams of submodules included in each entity module illustrated in FIG. 6, according to one or more embodiments.

### DETAILED DESCRIPTION

Various embodiments of the present disclosure relate generally to enterprise-level intelligence platforms and, more particularly, to systems and methods for transforming client experience through integrated, data-driven decision-making frameworks.

As discussed above, enterprises often collect valuable client-related data across numerous departments such as sales, marketing, risk management, and customer service. However, the data obtained by each department is frequently siloed, resulting in fragmented insights and missed opportunities for improving client satisfaction, reducing churn, and driving revenue growth. Existing systems may struggle to consolidate structured and unstructured data in real time or to interpret the data meaningfully across departmental boundaries.

The system, according to one or more examples of the present disclosure, addresses these shortcomings by providing a modular, AI-powered solution that synthesizes information from various enterprise systems (e.g., CRM, ticketing platforms, social media, financial reports, development tools, etc.) to create an integrated view of client behavior and needs. The system models data as entity modules (e.g., information, event, action, benchmark, etc.), which interact via a knowledge graph and entity-based JavaScript Object Notation (JSON) architecture. This enables seamless linking of communication records, product key performance indicators (KPIs), sales efforts, and client feedback across time and departments.

In some examples, the system may use autonomous AI agents and an analytical engine to process real-time signals, historical anecdotes, and business rules to suggest optimal actions. These agents may recommend personalized marketing outreach, escalate unresolved tickets, or flag at-risk clients for proactive engagement. Additionally, the system may support dynamic scaling of microservices based on transactional volume, ensuring both cost-efficiency and performance. Message queues and embedded time-stamped entities may be used to facilitate communication, state tracking, and timely updates across the system. Aspects of the disclosure further encompass robust benchmarking tools to help each department measure their effectiveness against strategic client experience goals.

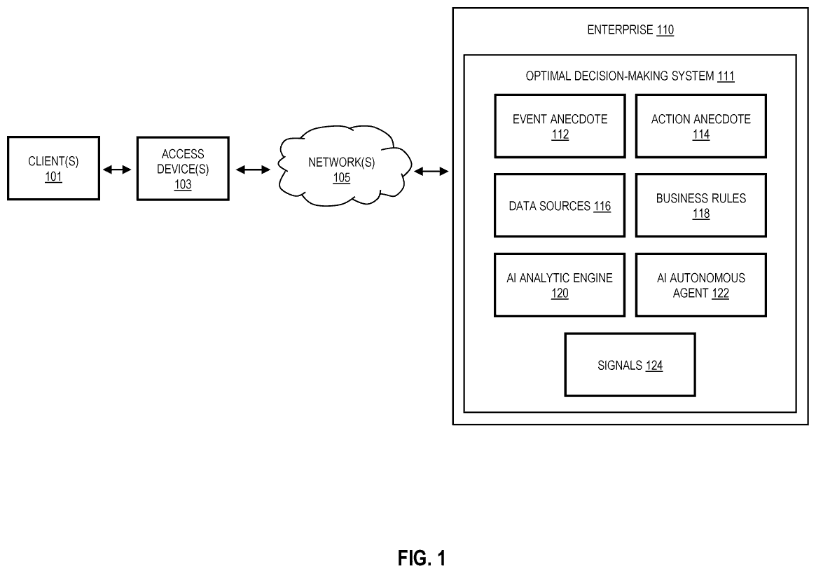

FIG. 1 illustrates an optimal decision-making system for enterprises based on client data, according to one or more embodiments. As shown in FIG. 1, one or more access devices 103 may be associated with the one or more clients 101, and an enterprise 110 may be in communication with the one or more access devices 103 through one or more networks 105. The enterprise may include an optimal decision-making system 111 configured to provide actionable insights for the enterprise 110 that improve the relationship with each of the one or more clients 101.

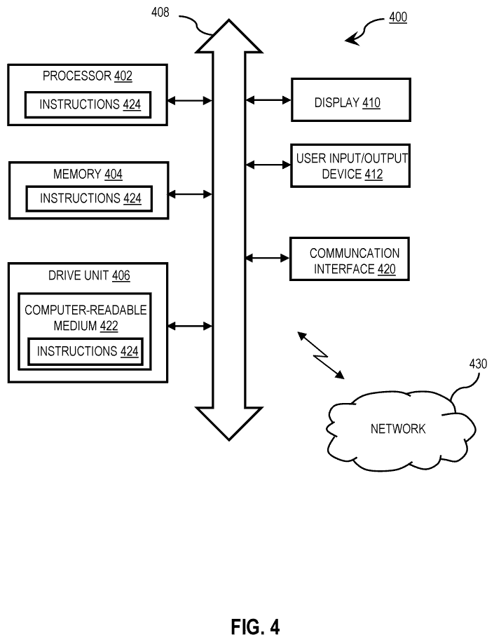

The one or more clients 101 may be individuals, companies, or other entities having an account with an enterprise, such as, e.g., a financial institution, software provider, a healthcare company, etc. The one or more access devices 103 may include any type of mobile, wireless, fixed, or portable terminal used by the one or more clients 101 to communicate with and/or access the enterprise 110. Examples of the one or more access devices 103 may include, but are not limited to, a mobile handset, a wireless communication device, a multimedia computer (e.g., computer system 400, described below with reference to FIG. 4), an Internet-enabled node, a data server, or any instrument or tool that enables the one or more clients 101 to initiate an online transaction.

The one or more clients 101 may have one or more registered access devices associated with an account with the enterprise 110. The one or more access devices 103 used by the one or more clients 101 for accessing the enterprise 110 may or may not be the registered access devices.

The one or more networks 105 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The one or more networks 105 may include wide area networks (WAN), such as the Internet, local area networks (LAN), campus area networks, metropolitan area networks, a direct connection such as through a Universal Serial Bus (USB) port, or any other networks that may allow for data communication. The one or more networks 105 may be configured to couple one computing device to another computing device to enable communication of data between the devices. The one or more networks 105 may generally be enabled to employ any form of machine-readable media for communicating information from one device to another. The one or more networks 105 may include communication methods by which information may travel between computing devices. The one or more networks 105 may be divided into sub-networks. The sub-networks may allow access to all of the other components connected thereto or the sub-networks may restrict access between the components. The one or more networks 105 may be regarded as a public or private network connection and may include, for example, a virtual private network or an encryption or other security mechanism employed over the public Internet, or the like.

Referring to FIG. 1, the optimal decision-making system 111 may include an event anecdote module 112, an action anecdote module 114, one or more data sources 116, business rules module 118, AI analytic engine module 120, AI autonomous agent module 122, and signals module 124. The optimal decision-making system 111 may be provided to improve client relationships and provide an AI-powered system to collect and analyze client data between departments.

Event anecdote module 112 may be configured to generate structured historical representations of enterprise activity. Event anecdote module 112 may be provided data from a combination of internal and external data sources 116, including, for example, Snow (for client support and ticketing data), JIRA (for development and project data), Salesforce (for sales and customer relationship data such as product usage data and customer relationship management data), and publicly available information such as news articles, financial reports, blogs, and social media content. The data gathered from the one or more data sources 116 may be structured or unstructured information. These sources may collectively provide a comprehensive view of historical client interactions, operational activity, and external influences. The one or more data sources 116 may continuously provide real-time updates via a stream. In this way, the optimal decision-making system 111 may be configured to operate in real-time by continuously receiving data from streaming data sources, allowing the optimal decision-making system 111 to update entity representation. The event anecdote module 112 may extract data points (e.g., relevant data points) to construct event-level insights, filtering out irrelevant information in order to streamline downstream processing.

The optimal decision-making system 111, via the event anecdote module 112, may analyze, timestamp, and organize the ingested data into entity-level formats to capture meaningful correlations between enterprise actions and client outcomes. For example, this may include upscale, cross-sales, new sales, net promoter score (NPS) changes, client feedback changes, or attrition. Event anecdote module 112 may be configured to perform pattern recognition, performance benchmarking, and/or predictive modeling.

Action anecdote module 114 may be configured to construct and analyze structured representations of historical enterprise actions. Action anecdote module 114 may receive data from a range of enterprise-wide data sources 116, including internal systems such as Salesforce, Snow, and JIRA, as well as external feeds such as financial reports, product release updates, and public communication channels. These data inputs may be processed and organized to identify enterprise-initiated activities intended to improve client experience or influence business outcomes. For example, some client experience improvements may include increased net promoter scores, enhanced upselling and cross-selling outcome, and reductions in client turnover rates.

Action anecdote module 114 may include submodules corresponding to specific types of enterprise actions, such as price reductions, new feature rollouts, product usage workflow improvements, and client service process enhancements. Each action may be captured as a timestamped event and linked to associated entities and outcomes within the optimal decision-making system 111. The integration of one or more data sources 116 into action anecdote module 114 may enable the optimal decision-making system 111 to correlate past actions with observed changes in client behavior, satisfaction, or financial performance, thereby supporting predictive modeling and evidence-based decision-making across business units.

Business rules module 118 may be configured to provide logic and constraints for guiding enterprise decision processes. The business rules module 118 may define conditional parameters, thresholds, and goal hierarchies used throughout the analytic workflows of the optimal decision-making system 111. In particular, business rules module 118 may include submodules for assigning priority levels to competing business objectives and for defining weightage values that quantify the relative importance of different data signals. These rule structures may be used by downstream components such as the AI analytic engine module 120 to inform predictive scoring and refine recommendation logic.

AI analytic engine module 120 may be responsible for processing input data, generating latent representations, and producing analytical outputs that guide client engagement strategies. The AI analytic engine module 120, via the one or more machine-leaning models included within, may identify entity relationships, such as how data for an event entity may be related to data for an action entity or to data for a different event entity. The AI analytic engine module 120 may comprise multiple submodules, including an encoder for transforming structured and unstructured inputs into embeddings, a decoder for reconstructing interpretable outputs, a prediction model for forecasting client behavior, an anomaly model for detecting deviations from expected patterns, and a recommendation model for suggesting optimal actions. The AI analytic engine module 120 may also define event entities for event anecdote module 112 based on aggregated temporal and relational patterns. In some embodiments, the system may apply at least three core AI models from the AI analytic engine module 120 (e.g., the prediction model, anomaly model, and recommendation model) to derive insights that support strategic enterprise decisions.

AI autonomous agent module 122 may be configured to serve as a decision interface between analytic outputs and enterprise actions. The AI autonomous agent module 122 may incorporate submodules for query retrieval, actionable insight generation, recommendation delivery, and workflow automation. The outputs produced by the AI analytic engine module 120 may include insights related to identified relationships between entities. Based on the outputs produced by the AI analytic engine module 120, the AI autonomous agent module 122 may summarize results, synthesize multiple recommendations, and/or provide prioritized action items to relevant enterprise users or systems. In some examples, the AI autonomous agent module 122 may act as a real-time execution layer that delivers decisions or initiates automated processes based on the other modules of the optimal decision-making system 111.

Signals module 124 may be configured to collect, normalize, and classify a wide array of data indicators used in evaluating enterprise performance and client experience. Signals module 124 may include both KPI-based submodules and non-KPI-based submodules, each representing distinct dimensions of business activity and client interaction. These signals may serve as foundational inputs to various downstream processes, including event anecdote generation (e.g., event anecdote module 112), AI model training (e.g., AI analytic engine module 120), and/or determining recommendations (e.g., AI autonomous agent module 122).

The KPI submodules within signals module 124 may include metrics grouped by functional area, such as client communication KPIs (e.g., email open rates, chat response times, etc.), development KPIs (e.g., development velocity, lead time, etc.), marketing KPIs (e.g., lead conversion, engagement analytics, etc.), client financial KPIs (e.g., cash conversion cycle, gross margin trends, etc.), client service KPIs (e.g., average resolution time), sales KPIs, and macro KPIs (e.g., GDP growth, inflation rate, etc.). In addition, the signals module 124 may include non-KPI submodules such as product information, communication metadata, content classification, etc. These various signals are determined from one or more data sources 116 and transformed into structured formats for further analysis via the AI analytic engine module 120, which integrates the signals into event entities in event anecdote module 112 and action entities in action anecdote module 114.

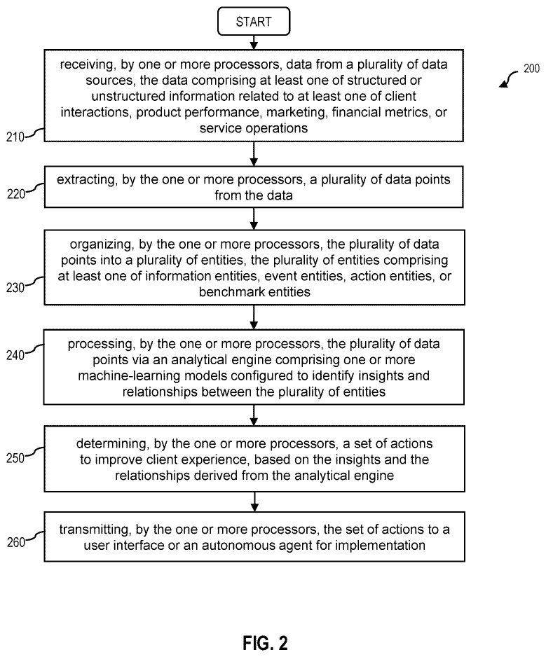

FIG. 2 is a flowchart showing a process for determining optimal actions, according to one or more embodiments. In various embodiments, the optimal decision-making system 111 and/or one or more components thereof may perform one or more portions of the process 200 and may be implemented using, for instance, a chip set including a processor and a memory as shown below in FIG. 4. As such, the optimal decision-making system 111 and/or any of components thereof may provide means for accomplishing various parts of the process 200, as well as means for accomplishing embodiments of other processes described herein in conjunction with other components of the optimal decision-making system 111. Although the process 200 is illustrated and described as a sequence of steps, it is contemplated that various embodiments of the process 200 are performed in any order or combination, need not include all of the illustrated steps, and may include additional or other steps.

In step 210, a system may receive data from a plurality of data sources. The data may include at least one of structured or unstructured information related to at least one of client interactions, product performance, marketing, financial metrics, or service operations. For example, the one or more data sources 116 of the optimal decision-making system 111 may receive data from an access device 103 associated with a client 101. The one or more data sources 116, such as Snow, JIRA, Salesforce, etc., may provide data to the other components of the optimal decision-making system 111.

In step 220, the system may extract a plurality of data points from the data. For example, the event anecdote module 112, the action anecdote module 114, and/or the AI analytic engine module 120 may extract relevant data points from the data provided by one or more data sources 116 to perform their respective functions.

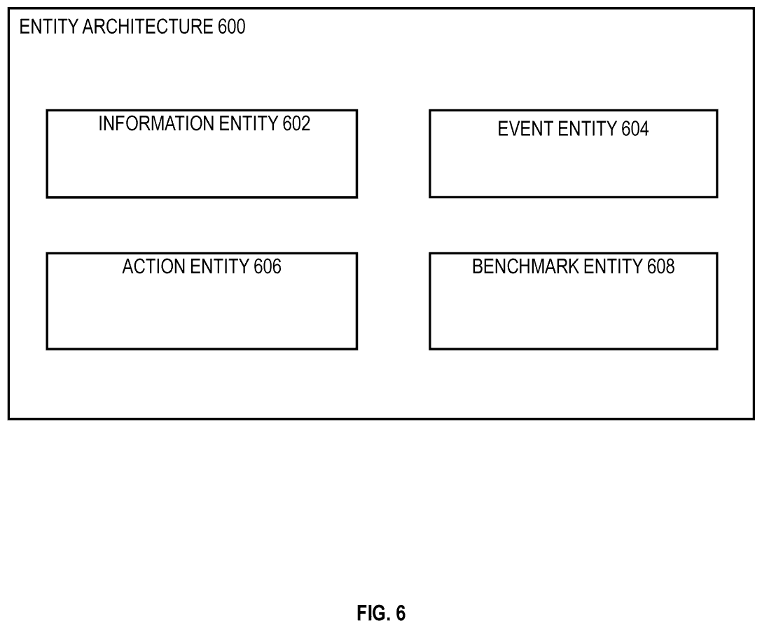

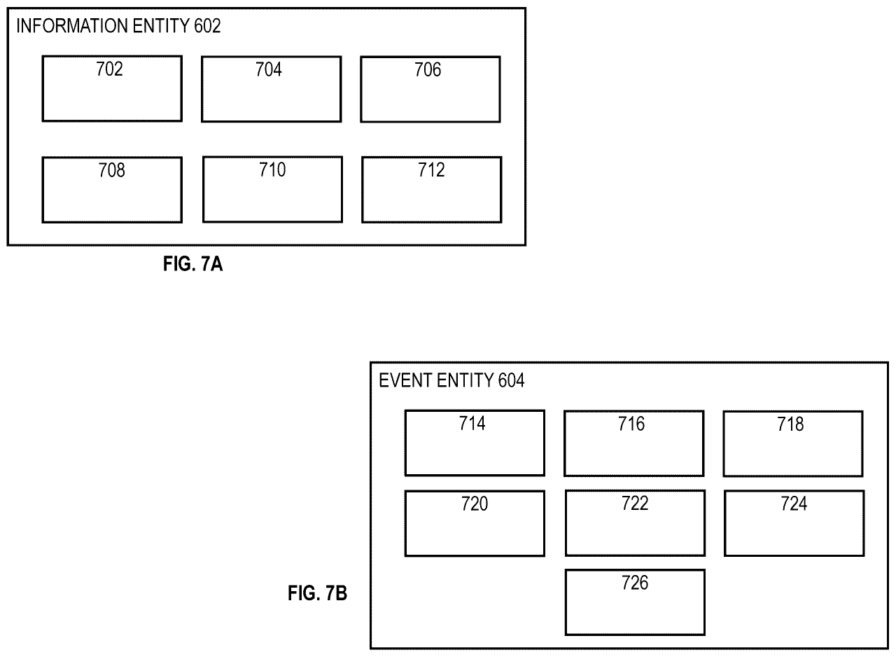

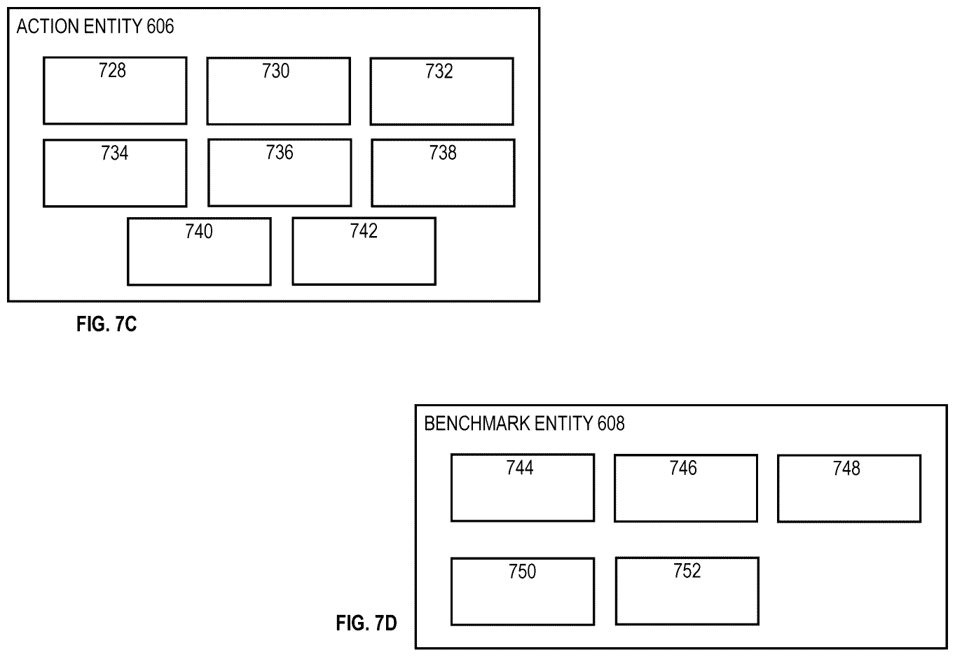

In step 230, the system may organize the plurality of data points into a plurality of entities. The plurality of entities may include at least one of information entities, event entities, action entities, or benchmark entities. For example, the data provided to and used by the event anecdote module 112, the action anecdote module 114, and/or the AI analytic engine module 120 may be organized based on an entity the data is associated with, as will be further described with respect to FIGS. 6-7D.

In step 240, the system may process the plurality of data points via an analytical engine comprising one or more machine-learning models configured to identify insights and relationships between the plurality of entities. For example, the data from one or more data sources 116 may be processed by AI analytic engine module 120, which includes one or more machine-learning models (e.g., a prediction model, an anomaly model, and a recommendation model), to identify any connections between the different entities.

In step 250, the system may determine a set of actions to improve client experience, based on the insights and the relationships derived from the analytical engine. For example, AI analytic engine module 120 may determine and recommend a set of actions, based on insights from the AI analytic engine module 120 (e.g., the machine-learning models), which are then sent to the AI autonomous agent module 122.

In step 260, the system may transmit the set of actions to a user interface or an autonomous agent for implementation. For example, the AI autonomous agent module 122 may determine the actions from the set of actions to implement automatically or to recommend to a user via a user interface. That is, the optimal decision-making system 111 may be configured to automatically implement any of the actions from the set of actions.

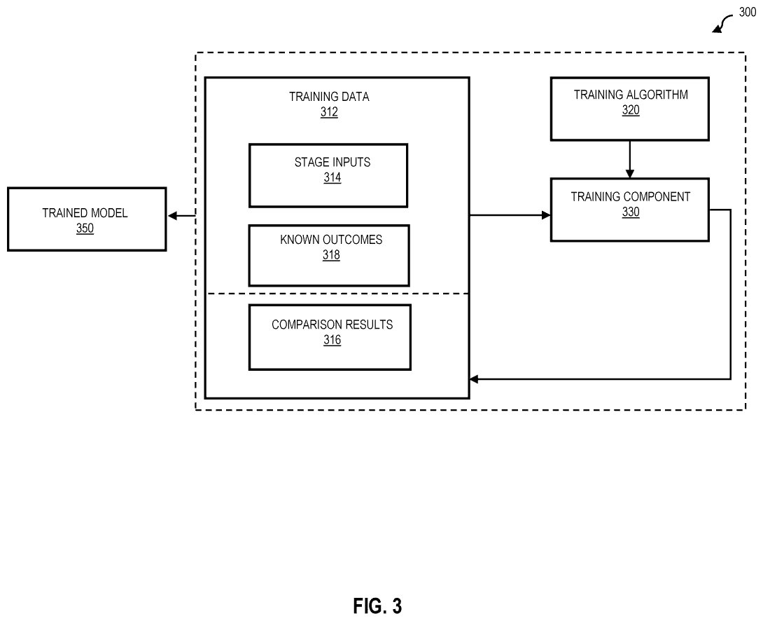

FIG. 3 depicts a flow diagram for training a machine-learning model, in accordance with an aspect of the disclosed subject matter. As shown in flow diagram 300 of FIG. 3, training data 312 may include one or more of stage inputs 314 and known outcomes 318 related to a machine-learning model to be trained. The stage inputs 314 may be from any applicable source including a component or set shown in the figures provided herein. The known outcomes 318 may be included for machine-learning models generated based on supervised or semi-supervised training. An unsupervised machine-learning model might not be trained using known outcomes 318. Known outcomes 318 may include known or desired outputs for future inputs similar to or in the same category as stage inputs 314 that do not have corresponding known outputs.

The training data 312 and a training algorithm 320 may be provided to a training component 330 that may apply the training data 312 to the training algorithm 320 to generate a trained machine-learning model 350. According to an implementation, the training component 330 may be provided comparison results 316 that compare a previous output of the corresponding machine-learning model to apply the previous result to re-train the machine-learning model. The comparison results 316 may be used by the training component 330 to update the corresponding machine-learning model. The training algorithm 320 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 300 may be a trained machine-learning model 350. In some examples, the trained machine-learning model 350 may be the machine learning module(s) utilized by the AI analytic engine module 120.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 400 may further include a display unit 410, such as a liquid crystal display (LCD), an organic light emitting diode (OLED), a flat panel display, a solid-state display, a cathode ray tube (CRT), a projector, a printer or other now known or later developed display device for outputting determined information. The display unit 410 may act as an interface for the user to see the functioning of the processor 402, or specifically as an interface with the software stored in the memory 404 or in a drive unit 406. For example, the display unit 410 may be the user interface that displays the recommended set of actions provided from the AI autonomous agent.

Additionally or alternatively, the computer system 400 may include an input/output device 412 configured to allow a user to interact with any of the components of system 400. The input/output device 412 may be a number pad, a keyboard, or a cursor control device, such as a mouse, or a joystick, touch screen display, remote control, or any other device operative to interact with the computer system 400.

The computer system 400 may also or alternatively include a disk or optical unit as the drive unit 406. The drive unit 406 may include a computer-readable medium 422 in which one or more sets of instructions 424, e.g., software, can be embedded. Further, the instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, a computer-readable medium 422 includes instructions 424 or receives and executes instructions 424 responsive to a propagated signal so that a device connected to a network 430 can communicate voice, video, audio, images, or any other data over the network 430. Further, the instructions 424 may be transmitted or received over the network 430 via a communication port or interface 420, and/or using a bus 408. The communication port or interface 420 may be a part of the processor 402 or may be a separate component. The communication port 420 may be created in software or may be a physical connection in hardware. The communication port 420 may be configured to connect with a network 430, external media, the display unit 410, or any other components in system 400, or combinations thereof. The connection with the network 430 may be a physical connection, such as a wired Ethernet connection or may be established wirelessly as discussed below. Likewise, the additional connections with other components of the system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 400 may be connected to one or more networks 430, such as network(s) 105. The network 430 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication. The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices. The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like. The network 430 may be the network 105, or another network.

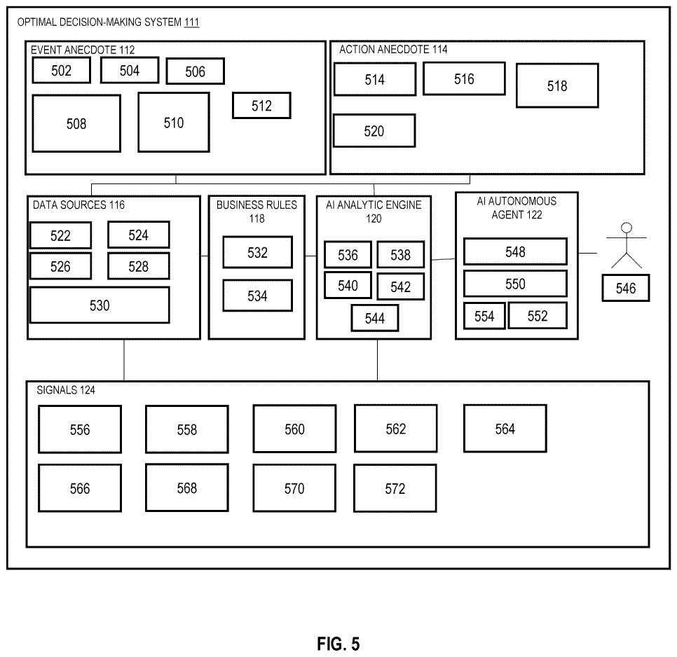

FIG. 5 illustrates a framework for the optimal decision-making system of FIG. 1, according to one or more embodiments. The event anecdote module 112 may include an upscale submodule 502, a cross-sales submodule 504, a new sales submodule 506, an NPS score submodule 508, a client feedback submodule 510, and a client attrition submodule 512. The event anecdote module 112 may organize the extracted data points from one or more data sources 116 into event entities. Each event entity may represent a basic unit of information related to a business event, as will be further described with respect to FIG. 6 and FIG. 7B. These entities may be stored and indexed by the optimal decision-making system 111 according to a standardized schema that supports integration with other types of entities (e.g., information entities, action entities, or benchmark entities).

In one example, the upscale submodule 502 may detect and log events in which an existing client expands their engagement by upgrading to a higher-tier service or purchasing additional licenses. Data points related to transactional upgrades may be extracted from CRM entries or billing logs and used to construct corresponding event entities. Similarly, the cross-sales submodule 504 may extract data from product catalogs to identify and organize instances in which a client acquired complementary offerings.

The new sales submodule 506 may focus on the initial acquisition of new clients, identifying these events from a plurality of sources such as, for example, onboarding records or deal closure alerts. The event anecdote module 112 may organize these data points into event entities that enable downstream systems to analyze acquisition drivers. The NPS score submodule 508 may extract structured or semi-structured survey data reflecting changes in Net Promoter Score and convert those into event entities linked to corresponding client journeys.

The client feedback submodule 510 may extract and process qualitative and quantitative inputs from communication channels, surveys, and support transcripts to form sentiment-based event entities. The client attrition submodule 512 may extract billing or usage-related data indicating reduced engagement or service cancellation and organize the data into attrition events. These events may be linked to other entities to support relationship identification during machine-learning analysis.

By extracting necessary data points from structured and unstructured sources and organizing them into event entities, the event anecdote module 112 may enable optimal decision-making system 111 to track, model, and analyze significant business outcomes. These event entities may later be processed by the AI analytic engine module 120 to identify patterns and relationships with other entity types, facilitating client experience optimization and outcome prediction.

The action anecdote module 114 may include a price change submodule 514, a new features submodule 516, a product usage workflow submodule 518, and a client service process submodule 520. The action anecdote module 114 may receive data from a plurality of internal and external data sources 116 (e.g., Salesforce, JIRA, Snow, and client communication systems) and may extract only the necessary data points that pertain to actionable changes, thereby filtering out unrelated or redundant information. The extracted data points may be organized by the action anecdote module 114 into action entities. Each action entity may correspond to a basic unit of information that can be considered as an action which is further discussed below.

In some examples, the price change submodule 514 may extract and classify changes to product pricing or subscription models from sales records. These data points may be organized into action entities that reflect the scope, timing, and target audience of the pricing change. The new features submodule 516 may identify product enhancements or functional releases recorded in development tools (e.g., JIRA), and may generate corresponding entities that link these actions to subsequent client activity or sentiment.

The product usage workflow submodule 518 may focus on internal actions aimed at improving how clients interact with a product (e.g., UI changes, onboarding optimizations, feature discoverability improvements, etc.). Relevant data points may be extracted from product usage sources and organized into workflow-focused action entities. Similarly, the client service process submodule 520 may extract data from client service sources to identify enhancements for client support procedures. Such enhancements may include process changes like reduced response times, proactive outreach policies, or case routing improvements.

One or more data sources 116 may include a JIRA submodule 522, a Snow submodule 524, a Salesforce submodule 526, a news submodule 528, and a social media submodule 530. The submodules within one or more data sources 116 may provide data to the event anecdote module 112, the action anecdote module 114, the AI analytic engine module 120, and/or the signals module 124. The one or more data sources 116 compile and store any necessary data for the optimal decision-making system 111 to accurately provide optimal recommendations and/or actions.

The business rules module 118 may include a priorities submodule 532 and a weightage submodule 534. The business rules module 118 may be configured to define and enforce logic-based constraints such as, for example, decision hierarchies within the workflows of the optimal decision-making system 111. The rules implemented within the business rules module 118 may impact how insights are weighted and prioritized during processing.

Priorities submodule 532 may be configured to assign rankings to data based on importance from one or more data sources 116 (e.g., specific business objectives, desired system outputs, types of client-related outcomes, etc.). For example, the optimal decision-making system 111 may be configured to prioritize reducing client attrition over increasing cross-sales or to prioritize responding to negative feedback over responding to delayed purchases. These priority levels may be applied dynamically or contextually, such as, for example, based on segment-specific rules or historical performance metrics.

Weightage submodule 534 may assign numerical or categorical weights to various data features. The weightage submodule 534 may even assign weights to signals or relationships between entities. These weights may serve as modifiers within the AI models (e.g., prediction model 536, anomaly model 538, or recommendation model 540) used by the AI analytic engine module 120. For example, a higher weight may be assigned to client financial KPIs in business-to-business (B2B) enterprise environments, while a higher weight may be assigned to behavioral communication data in consumer-facing environments. The weightage values used by the weightage submodule 534 may be static, rule-based, or dynamically adjusted based on observed effectiveness or calibration feedback from autonomous agents.

The AI analytic engine module 120 may be configured to process a plurality of data points and entities for the purpose of identifying patterns, extracting insights, and generating recommendations relevant to enterprise decision-making. The data processed by the AI analytic engine module 120 may be provided by one or more data sources 116, the event anecdote module 112, and/or the action anecdote module 114, and may be organized into entities (e.g., event entities, action entities, information entities, and benchmark entities). The AI analytic engine module 120 may apply a series of AI-based models and transformation submodules to evaluate relationships among the entities. To do so, the AI analytic engine module 120 may include the prediction model 536, the anomaly model 538, the recommendation model 540, an encoder submodule 542, and a decoder submodule 544.

Encoder submodule 542 may be configured to receive structured and unstructured data inputs, including those represented as entities, and to transform these inputs into latent vector representations using embedding techniques. The encoded representations of the data may serve as inputs to one or more downstream models within the engine.

Decoder submodule 544 may be responsible for converting latent representations or model outputs into interpretable results. The decoder submodule 544 may reconstruct insights into human-readable formats and may translate recommendation vectors into specific business interventions. In some examples, the decoder submodule 544 may also apply business logic or formatting protocols to ensure that outputs are properly contextualized for autonomous or human review.

Prediction model 536 may be configured to forecast future outcomes or behaviors based on historical entity interactions. For example, the prediction model 536 may estimate, by using historical event entity data and action entity data, client churn probability, likelihood of cross-sale success, or anticipated satisfaction score changes. The prediction model 536 may leverage supervised learning techniques, recurrent architectures, or probabilistic classifiers depending on the data modality and use case.

Anomaly model 538 may detect deviations from expected behaviors or patterns within the entity framework. The anomaly model 538 may analyze temporal and/or relational inconsistencies in the data. Further, the anomaly model 538 may flag anomalous client interactions or events. Anomalies may be indicative of system issues or unexpected shifts in client behavior and may be escalated for further review or autonomous handling by the AI autonomous agent module 122. The anomaly model 538 may enable the optimal decision-making system 111 to detect anomalies in benchmark entity performance metrics over a defined time window (e.g., a predefined period) and identify one or more root cause event entities correlated with the anomalies. As will be described below, the recommendation model 540 may recommend targeted action entities to address the one or more root cause event entities.

Recommendation model 540 may be configured to evaluate entity relationships and derive actionable steps aimed at optimizing client experience and business performance. The recommendation model 540 may utilize encoded data and predictive insights while factoring in business rules from the business rules module 118 and/or historical anecdotal patterns to determine one or more actions (e.g., a set of actions) suitable for a given situation. These actions may include, for example, initiating a cross-sale campaign, enhancing product support, adjusting service prioritization, or re-engaging an at-risk client.

The outputs of the AI analytic engine module 120 (e.g., recommended actions, identified risks, client state predictions, etc.) may be provided to downstream components such as the AI autonomous agent module 122. The outputs may then subsequently be delivered to an end user 546 or to the optimal decision-making system 111 to automatically determine optimal changes. Accordingly, the AI analytic engine module 120 may enable the optimal decision-making system 111 to intelligently process structured and unstructured enterprise data and extract relationships across entities.

The AI autonomous agent module 122 may receive the outputs of the AI analytic engine module 120 and facilitate the delivery or execution of decision recommendations. The AI autonomous agent module 122 may act as a bridge between the analyzed data and either human users (e.g., the end user 546) or enterprise systems (e.g., the optimal decision-making system 111). The AI autonomous agent module 122 may determine how recommended actions are presented, prioritized, or implemented. The AI autonomous agent module 122 may be deployed across multiple environments (e.g., web-based dashboards, client-facing portals, etc.). The AI autonomous agent module 122 may include a query retrieval submodule 548, an actionable insights submodule 550, a recommendation submodule 552, and an automation submodule 554.

Query retrieval submodule 548 may be configured to receive and process queries from users or systems. These queries may include requests for current client status, historical event summaries, recommended actions, or forecasted outcomes. Based on a selected action provided to the end user 546, the query retrieval submodule 548 may be configured to receive feedback from the end user 546 regarding the selected action. The user feedback received by the AI autonomous agent module 122 may be used to retrain one or machine-learning models within the AI analytic engine module 120, thereby improving future decision accuracy. The query retrieval submodule 548 may retrieve relevant entity relationships and/or analytic outputs for presentation or further processing.

Actionable insights submodule 550 may receive outputs from the AI analytic engine module 120 and convert them into summarized insight packages. These packages may include predictive metrics, anomaly alerts, or other pertinent insights related to the data provided. The insights may be filtered, prioritized, annotated, etc. based on the business rules module 118 to ensure relevance. In some examples, the insights may be illustrated or communicated through configurable dashboards or system notifications.

Recommendation submodule 552 may interpret the outputs of the recommendation model 540 and determine which actions from the recommended set should be presented to users for manual consideration versus which may be handled autonomously. Additionally or alternatively, the recommendation submodule 552 may determine a subset of recommended actions from the recommended set generated by the recommendation model 540 and provide the subset to the end user 546 and/or automatically perform the subset of actions. In some examples, the recommendation submodule 552 may confirm or reject the recommended set of actions provided by the recommendation model 540. The recommendation submodule 552 may group the recommendations based on priority levels or historical effectiveness determined by the AI analytic engine module 120 and/or the business rules module 118. These recommendations and/or subsequent actions may include suggestions for initiating marketing outreach, altering product development focus, recommending client support interventions, prioritizing customer segments, adjusting pricing, improving client workflows, or enhancing support response protocols.

Automation submodule 554 may be configured to autonomously execute one or more actions without requiring manual approval. These actions may be triggered based on predefined rules. For example, the automation submodule 554 may execute an action autonomously if the action meets a certain model confidence threshold or detected risk level. In this scenario, the optimal decision-making system 111 may automatically send a follow-up communication to a client, route a support ticket to a specialized team, or initiate a retention workflow for an at-risk account. The automation submodule 554 may also integrate with external systems (e.g., CRM, marketing automation, support platforms, etc.) to perform these actions with the external systems.

Signals module 124 may be configured to categorize enterprise-level indicators used for analytics and decision optimization. The signals module 124 may receive raw data from one or more data sources 116 and/or analyzed data from the AI analytic engine module 120. These data points may be organized into a plurality of signal categories, each representing a specific operational or behavioral dimension relevant to enterprise performance and client experience. Specifically, the signals module 124 may include a client communication KPIs submodule 556, development KPIs submodule 558, marketing KPIs submodule 560, client financial KPIs submodule 562, product submodule 564, client service KPIs submodule 566, sales KPIs submodule 568, macro KPIs submodule 570, and a communication submodule 572. Each submodule may be configured to extract and normalize relevant data metrics such as, for example, first response time, development velocity, campaign effectiveness, gross margin fluctuations, product usage behavior, or macroeconomic conditions.

The submodules within the signals module 124 may correspond to and supply data for submodules within each of the four entity types previously described: information entity, event entity, action entity, and benchmark entity. Each entity and the submodules included within each entity will be further described below with respect to FIGS. 6-7D.

FIG. 6 illustrates a diagram of entity modules, according to one or more embodiments. Entity architecture 600 may include one or more entity modules, such as information entity module 602, event entity module 604, action entity module 606, and benchmark entity module 608. Each of the information entity module 602, the event entity module 604, the action entity module 606, and the benchmark entity module 608 may include submodules that collect data that is relevant for the respective modules. The entity modules are used throughout the optimal decision-making system 111 as described above and as will be further described below.

The information entity module 602 may include entities created from one or more data sources (e.g., one or more data sources 116). These entities may be considered signals (e.g., included in the signals module 124) such as, for example, various KPIs. The news of a merger of a client may be considered an information entity and included in the information entity module 602. The event entity module 604 may include entities that are considered as relevant events. For example, an event entity may be created when cross-sales drops or when client attrition increases.

The action entity module 606 may include entities that are considered as actions. For example, an action entity may be generated when a product is recommended to a client to increase cross-sales or when a compliance feature for a product is suggested to help retain a client. The benchmark entity module 608 may include entities that are considered a benchmark standard. Deviating from the standard provided by the benchmark entities may trigger autonomous agents (e.g., AI autonomous agent module 122) to find a solution via a recommendation (e.g., recommendation model 540) or a prediction (e.g., prediction model 536). For example, the benchmark entities may create a benchmark for average yearly client retention within three years, the benchmark being a retention rate of 90% or greater.

The entities from each of the information entity module 602, the event entity module 604, the action entity module 606, and the benchmark entity module 608 may include an embedded representation in a latent space. In this way, the embedded representation of the entity may preserve dimensional alignment across time-varying attribute changes. Further, the entities may be uniquely identified using a hierarchical identifier. The hierarchical identifier may include a module name, an entity class name, and an entity name. For example, the hierarchical identifier may indicate the entity is related to a certain category of data (e.g., client finance data) within a certain submodule (e.g., economics and finance) within a certain module (e.g., the information entity module 602).

FIGS. 7A-7D depict diagrams of submodules included in each entity module illustrated in FIG. 6, according to one or more embodiments. Referring to FIG. 7A, the information entity module 602 may include economics and finance submodule 702, client communications submodule 704, product development submodule 706, client services submodule 708, sales submodule 710, and marketing submodule 712. The economics and finance submodule 702 within the information entity module 602 may include data related to client finances and/or macroeconomics. The client communications submodule 704 within the information entity module 602 may include data related to direct communication (e.g., phone recordings, email, chat, etc.), social media, and/or ticketing systems. The product development submodule 706 within the information entity module 602 may include data related to existing products, plans for new products, and/or plans for existing product changes. The client services submodule 708 within the information entity module 602 may include data related to client infrastructure, platforms used by the client, and/or product support. The sales submodule 710 within the information entity module 602 may include data related to CRM, sales analytics, and/or sales reporting. The marketing submodule 712 within the information entity module 602 may include data related to email marketing, social media campaigns, lead generation, lead nurturing, marketing analysis, and/or marketing reporting.

Referring to FIG. 7B, the event entity module 604 may include external submodule 714, client attrition submodule 716, client feedback submodule 718, client sales submodule 720, internal submodule 722, competitor submodule 724, and business transformation submodule 726. The external submodule 714 within the event entity module 604 may include data related to client mergers, client acquisitions, client market sentiment, and/or prospective clients. The client attrition submodule 716 within the event entity module 604 may include data related to lost client rates, notices of discontinuing services, client escalated issues, and/or client issues reported in the news. The client feedback submodule 718 within the event entity module 604 may include data related to client NPS changes, client feedback score changes, and/or general client feedback. The client sales submodule 720 within the event entity module 604 may include data related to upsell changes, cross-sell changes, and/or new sale changes. The internal submodule 722 within the event entity module 604 may include data related to product acquisition, product sunset, market sentiment changes, and/or market valuation changes. The competitor submodule 724 within the event entity module 604 may include data related to new product features, sales and/or marketing channel changes, and/or cost structure changes. The business transformation submodule 726 within the event entity module 604 may include data related to head count changes, support changes, and/or development changes.

Referring to FIG. 7C, the action entity module 606 may include business owners submodule 728, product client support submodule 730, platform and infrastructure support submodule 732, development submodule 734, product management submodule 736, sales submodule 738, marketing submodule 740, and vendors submodule 742. The business owners submodule 728 within the action entity module 606 may include data related to capital markets, banking, infrastructure, and/or platform. The product client support submodule 730 within the action entity module 606 may include data related to one or more product lines. The platform and infrastructure support submodule 732 within the action entity module 606 may include data related to one or more support groups. The development submodule 734 within the action entity module 606 may include data related to one or more product development plans. The product management submodule 736 within the action entity module 606 may include data related to one or more product management teams. The sales submodule 738 within the action entity module 606 may include data related to one or more sales teams. The marketing submodule 740 within the action entity module 606 may include data related to one or more marketing teams. The vendors submodule 742 within the action entity module 606 may include data related to one or more vendors.

Referring to FIG. 7D, the benchmark entity module 608 may include economics and finance submodule 744, client communications submodule 746, product development submodule 748, client services submodule 750, and/or sales and marketing submodule 752. The economics and finance submodule 744 within the benchmark entity module 608 may include data related to benchmarks for client finance and/or macroeconomics. The client communications submodule 746 within the benchmark entity module 608 may include data related to benchmarks for direct communication (e.g., phone recordings, email, chat, etc.), social media, and/or ticketing systems. The product development submodule 748 within the benchmark entity module 608 may include data related to benchmarks for existing products, plans for new products, and/or plans for existing product changes. The client services submodule 750 within the benchmark entity module 608 may include data related to benchmarks for client infrastructure, platforms used by the client, and/or product support. The sales and marketing submodule 752 within the benchmark entity module 608 may include data related to benchmarks for cross-sales, upsells, and/or new sales. Each benchmark entity may include a time-dependent performance target derived from aggregated historical data across industry or enterprise benchmarks.

As previously described, the optimal decision-making system 111 may organize data extracted from one or more data sources 116 into a plurality of entities, including information entities grouped in the information entity module 602, event entities grouped in the event entity module 604, action entities grouped in the action entity module 606, and benchmark entities grouped in the benchmark entity module 608. Each entity may be represented in at least one of a machine-readable JSON format or a knowledge graph format. These representations may include timestamped attribute data and inter-entity relationship data derived from the signals module 124 and other upstream components.

The JSON format may be structured with module-wise time series attributes such that each module (e.g., development KPIs submodule 558, client financial KPIs submodule 562, etc.) reflects domain-specific metrics tracked over time. Relational links may be encoded within the JSON structure to define associations between entities, such as a client service event linked to a product release action. For example, both the information entity module 602 and the action entity module 606 include a sales submodule. The optimal decision-making system 111 may be configured to recognize this type of relationship between entities.

The knowledge graph format may use node-edge structures in which the nodes represent entities, and the edges encode semantic and temporal relationships. The optimal decision-making system 111 may update the knowledge graph as new data is received or as relationships evolve such as, for example, linking a new client sale event entity to a preceding price reduction action entity. These updates may reflect changes in edge types, timestamps, inter-entity relationships, or link strength. Thus, the updates may enable the graph to dynamically evolve alongside client and enterprise activity.

To support AI-driven analysis, the optimal decision-making system 111 may also generate embedded representations of each entity in a latent space using the encoder submodule 542 of AI analytic engine module 120. These embeddings may preserve dimensional consistency over time, despite changes in entity attributes or relationships, allowing downstream models (e.g., prediction model 536, anomaly model 538, recommendation model 540, etc.) to process entities with temporal and semantic context intact.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for autonomous decision optimization, the method comprising:
receiving, by one or more processors, data from a plurality of data sources, the data comprising at least one of structured or unstructured information related to at least one of client interactions, product performance, marketing, financial metrics, or service operations;
extracting, by the one or more processors, a plurality of data points from the data;
organizing, by the one or more processors, the plurality of data points into a plurality of entities, the plurality of entities comprising at least one of information entities, event entities, action entities, or benchmark entities;
processing, by the one or more processors, the plurality of data points via an analytical engine comprising one or more machine-learning models configured to identify insights and relationships between the plurality of entities;
determining, by the one or more processors, a set of actions to improve client experience, based on the insights and the relationships derived from the analytical engine; and
transmitting, by the one or more processors, the set of actions to a user interface or an autonomous agent for implementation.

2. The computer-implemented method of claim 1, wherein the data includes at least one of customer relationship management data, ticketing data, product usage data, software development data, financial news data, or social media content data.

3. The computer-implemented method of claim 1, further comprising:
representing, by the one or more processors, each entity of the plurality of entities in at least one of a machine-readable JSON format or a knowledge graph format, each entity of the plurality of entities comprising timestamped attribute data and inter-entity relationship data.

4. The computer-implemented method of claim 1, further comprising:
automatically implementing, by the one or more processors, at least one of the set of actions.

5. The computer-implemented method of claim 1, wherein the set of actions comprises at least one of initiating marketing outreach, altering product development focus, recommending client support interventions, or prioritizing customer segments.

6. The computer-implemented method of claim 1, wherein the set of actions is determined based on correlation between historical event entities and benchmark performance metrics.

7. The computer-implemented method of claim 1, wherein the set of actions is provided to one or more autonomous AI agents configured to execute workflows based on the set of actions.

8. The computer-implemented method of claim 1, further comprising:
detecting, by the one or more processors, anomalies in benchmark entity performance metrics over a defined time window;
identifying, by the one or more processors, one or more root cause event entities correlated with the anomalies; and
recommending, by the one or more processors, targeted action entities to address the one or more root cause event entities.

9. The computer-implemented method of claim 1, wherein each entity of the plurality of entities is uniquely identified using a hierarchical identifier comprising a module name, an entity class name, and an entity name.

10. The computer-implemented method of claim 1, wherein the client experience improvements include increased net promoter scores, enhanced upselling and cross-selling outcomes, and reductions in client turnover rates.

11. The computer-implemented method of claim 1, wherein each benchmark entity includes a time-dependent performance target derived from aggregated historical data across industry or enterprise benchmarks.

12. The computer-implemented method of claim 1, further comprising:
receiving user feedback related to a selected action;
retraining, by the one or more processors, the one or more machine-learning models based on the user feedback to improve future decision accuracy.

13. The computer-implemented method of claim 1, wherein the one or more machine-learning models are trained using historical data comprising at least one of past event outcomes, client feedback, benchmark targets, or action effectiveness metrics.

14. A system for autonomous decision optimization, the system comprising:
a memory storing instructions and one or more machine-learning models; and
a processor operatively connected to the memory and configured to execute the instructions to perform operations including:
receiving, by one or more processors, data from a plurality of data sources, the data comprising at least one of structured or unstructured information related to at least one of client interactions, product performance, marketing, financial metrics, or service operations;
extracting, by the one or more processors, a plurality of data points from the data;
organizing, by the one or more processors, the plurality of data points into a plurality of entities, the plurality of entities comprising at least one of information entities, event entities, action entities, or benchmark entities;
processing, by the one or more processors, the plurality of data points via an analytical engine comprising the one or more machine-learning models configured to identify insights and relationships between the plurality of entities;
determining, by the one or more processors, a set of actions to improve client experience, based on the insights and the relationships derived from the analytical engine; and
transmitting, by the one or more processors, the set of actions to a user interface or an autonomous agent for implementation.

15. The system of claim 14, wherein the processor operatively connected to the memory and configured to execute the instructions to perform operations further includes:
representing each of the plurality of entities in at least one of a machine-readable JSON format or a knowledge graph format, each entity of the plurality of entities comprising timestamped attribute data and inter-entity relationship data.

16. The system of claim 14, wherein the set of actions is provided to one or more autonomous AI agents configured to execute workflows based on the set of actions.

17. The system of claim 14, wherein the system is configured to operate in real-time by continuously receiving and updating entity representations from streaming data sources.

18. The system of claim 14, wherein the processor operatively connected to the memory and configured to execute the instructions to perform operations further includes:
automatically implementing at least one of the set of actions.

19. A non-transitory machine-readable medium storing instructions that, when executed by one or more processors, cause a client experience system to perform a method for autonomous decision optimization, the method comprising:
receiving, by one or more processors, data from a plurality of data sources, the data comprising at least one of structured or unstructured information related to at least one of client interactions, product performance, marketing, financial metrics, or service operations;
extracting, by the one or more processors, a plurality of data points from the data;
organizing, by the one or more processors, the plurality of data points into a plurality of entities, the plurality of entities comprising at least one of information entities, event entities, action entities, or benchmark entities;
processing, by the one or more processors, the plurality of data points via an analytical engine comprising one or more machine-learning models configured to identify insights and relationships between the plurality of entities;
determining, by the one or more processors, a set of actions to improve client experience, based on the insights and the relationships derived from the analytical engine; and
transmitting, by the one or more processors, the set of actions to a user interface or an autonomous agent for implementation.

20. The non-transitory machine-readable medium of claim 19, the method performed by the client experience system further comprising:
automatically implementing at least one of the set of actions.
